(19) United States
(12) Patent Application Publication
(10) Pub. No.: US 2024/0195009 A1
(43) Pub. Date: Jun. 13, 2024

(54) Battery Receiving System

(71) Applicant: Lisa Dräxlmaier GmbH, Vilsbiburg (DE)

(72) Inventors: Andreas Linner, Oberneukirchen (DE); Peter Wagner, Karlsfeld (DE)

(73) Assignee: Lisa Dräxlmaier GmbH, Vilsbiburg (DE)

(21) Appl. No.: 18/287,900

(22) PCT Filed: Apr. 13, 2022
(86) PCT No.: PCT/EP2022/059877

§ 371 Date: Oct. 23, 2023

(30) Foreign Application Priority Data
Apr. 23, 2021 (DE) 10 2021 110 418.1

(51) Int. Cl. H01M 50/383; H01M 10/625; H01M 10/658; H01M 50/249; H01M 50/51

(52) U.S. Cl. CPC H01M 50/383; H01M 10/625; H01M 10/658; H01M 50/249; H01M 50/51; H01M 2220/20

(57) ABSTRACT

The present invention relates to a battery mounting system for holding a plurality of battery cells in an electrically drivable vehicle. The system comprises a mounting housing for holding the plurality of battery cells. The battery cells are arranged in a plurality of battery cell rows positioned parallel to each other, the battery cells of the battery cell rows extending along a longitudinal direction. A plurality of electrical connection elements are arranged to electrically conductively connect two adjacent battery cells of the respective battery cell row along the longitudinal direction in order to provide an electrical series connection of the respective battery cell rows. At least one heat protection element is arranged between two battery cells of the respective battery cell row adjacent along the longitudinal direction and configured to provide a heat protection barrier between the two adjacent battery cells of the respective battery cell row.

### CROSS REFERENCE TO RELATED APPLICATIONS

This application is a national phase application of International Application No.: PCT/EP2022/059877, filed on Apr. 13, 2022, and further claims priority to German patent application 102021110418.1, filed on Apr. 23, 2021, the content of both of which is incorporated herein by reference.

### BACKGROUND OF THE INVENTION

### Field of the Invention

The invention relates to a battery mounting system for mounting a plurality of battery cells in an electrically drivable vehicle.

### Description of Related Art

A battery mounting system is used in a conventional electrically driven vehicle to hold a plurality of battery cells that provide the electrical energy required to drive the electrically drivable vehicle. Typically, battery cells based on lithium-ion technology are used, but these can be converted into a thermally unstable state by certain external influences, such as overheating, overcharging and/or mechanical damage.

If one battery cell of the plurality of battery cells is converted into a thermally unstable state, a large amount of hot gases under high pressure is released into the environment of the battery cell within a short time through a pressure relief valve of the battery cell. Due to the usually dense packing of the battery cells within the battery mounting system, the hot gases released by the thermally unstable battery cell can also transfer adjacent battery cells into a thermally unstable state. Under certain circumstances, this can result in a chain reaction that can severely damage or even destroy a large number of battery cells.

### BRIEF SUMMARY OF THE INVENTION

It is an objective of the present invention to provide a battery mounting system of an electrically driven vehicle which, in the event of the occurrence of a thermally unstable state of one battery, protects the adjacent batteries of the battery mounting system from damage.

The present invention is based on the understanding that a heat protection barrier of the battery mounting system ensures that hot gases released by a thermally unstable battery cell cannot thermally excite adjacent battery cells.

In this case, the battery cells held in the battery mounting system are arranged in a plurality of battery cell rows positioned parallel to one another, the battery cells of the respective battery cell rows being electrically connected in series by a plurality of electrical connection elements.

The heat protection barrier is provided by at least one heat protection element, which is arranged between two adjacent battery cells of the respective battery cell row and provides a thermal barrier between the two adjacent battery cells.

According to a first aspect of the invention, the objective is solved by a battery mounting system for holding a plurality of battery cells in an electrically drivable vehicle, comprising a mounting housing for holding the plurality of battery cells, the plurality of battery cells being held in the mounting housing, the battery cells being arranged in a plurality of battery cell rows positioned parallel to each other, the battery cells of the battery cell rows extending along a longitudinal direction, a plurality of electrical connection elements each electrically conductively connecting two battery cells of the respective battery cell row adjacent to each other along the longitudinal direction in order to provide an electrical series connection of the respective battery cell rows, and at least one heat protection element disposed between two longitudinally adjacent battery cells of the respective battery cell row and adapted to provide a heat protection barrier between the two adjacent battery cells of the respective battery cell row.

Thereby, the technical advantage is achieved that the at least one heat protection element provides an effective heat protection barrier between the two adjacent battery cells of the respective battery cell row, so that if one of the two adjacent battery cells is converted into a thermally unstable state, the other of the two adjacent battery cells is prevented from also being converted into a thermally unstable state.

The heat protection element is formed using a material, which has a high thermal resistance and a high resistance to pressure. In particular, the material of the heat protection element comprises at least one metal, in particular steel, iron and/or aluminium. In particular, the heat protection element is formed as a heat protection plate. In particular, the heat protection plate has at least one elevation and/or at least one depression.

In particular, the at least one heat protection element may comprise a plurality of heat protection elements, wherein one heat protection element of the plurality of heat protection elements is arranged between each two battery cells of the respective battery cell rows that are adjacent along the longitudinal direction and is configured to provide a heat protection barrier between the two adjacent battery cells of the respective battery cell rows. Thus, the plurality of heat protection elements can ensure a plurality of effective heat protection barriers between a plurality of longitudinally adjacent battery cells in a battery cell row, or in a plurality of the battery cell rows positioned parallel to each other.

In particular, the at least one heat protection element may extend beyond the respective battery cell row and is arranged between battery cells adjacent to each other along a longitudinal direction in a plurality of battery cell rows positioned parallel to each other.

In particular, the at least one heat protection element can extend at least in sections, in particular completely, along a transverse direction running transversely to the longitudinal direction in the mounting housing and/or the at least one heat protection element can extend at least in sections, in particular completely, along an upward direction running transversely to the longitudinal direction and transversely to a transverse direction in the mounting housing.

Thus, the at least one heat protection element provides, in particular, an effective heat protection barrier extending over the surface inside the mounting housing.

In particular, the at least one heat protection element arranged between the two battery cells of the respective battery cell row adjacent along the longitudinal direction has at least one opening to enable an electrical connection between the two battery cells of the respective battery cell row adjacent along the longitudinal direction by means of the respective electrical connection element.

In the context of the present disclosure, battery cells “adjacent” to each other along a longitudinal direction refer to adjacent battery cells of a single battery cell row.

The battery cells according to the present disclosure each comprise opposite poles, in particular plus pole and minus pole. Here, in particular, one pole, in particular plus pole or minus pole, of one of the two longitudinally adjacent battery cells of the respective battery cell row is electrically connected by the respective electrical connection element to an opposite pole, in particular minus pole or plus pole, of the other of the two longitudinally adjacent battery cells.

Due to the plurality of electrical connection elements, which electrically connect adjacent battery cells in the respective battery cell row in the longitudinal direction, an effective electrical series connection of the respective battery cell row can be achieved. The respective electrically series-connected plurality of battery cell rows positioned parallel to each other in the mounting housing enables an effective energy density of the entire battery mounting system.

In the context of the present disclosure, “side by-side” battery cells refer to battery cells of different battery cell rows positioned parallel to each other.

In particular, the rows of battery cells positioned parallel to each other in the mounting housing are spaced apart from each other or the rows of battery cells positioned parallel to each other in the mounting housing are adjacent to each other.

In particular, battery cells arranged next to each other from different battery cell rows positioned parallel to each other are positioned without an offset along the longitudinal direction. In particular, battery cells arranged next to each other from different battery cell rows positioned parallel to each other are positioned with an offset along the longitudinal direction.

In particular, the battery cells according to the present disclosure comprise round cells.

Thus, the at least one heat protection element according to the present disclosure effectively prevents a propagation of thermally unstable states of a plurality of battery cells within the battery mounting system, so that battery cells based on lithium-ion technology, which have a particularly high energy density, can still be used.

Due to the at least one heat protection element according to the present disclosure, a particularly tight packing of the battery cells in the battery mounting system can be further ensured by the plurality of battery cell rows positioned parallel to each other, without the risk of thermally unstable states spreading to neighbouring battery cells. Thus, an installation space-optimised battery mounting system can be provided.

In one embodiment, the at least one heat protection element is arranged between the respective electrical connection element of the plurality of electrical connection elements and one of the two adjacent battery cells of the respective battery cell row.

This achieves the technical advantage of ensuring a particularly advantageous production of the battery mounting system.

In particular, the respective electrical connection element is connected to one of the two adjacent battery cells of the respective battery cell row in a firmly bonded manner and the respective electrical connection element is connected to the other of the two adjacent battery cells of the respective battery cell row in a non-positive and/or positive manner, wherein in particular the at least one heat protection element is arranged between the respective electrical connection element and the firmly bonded battery cell of the respective battery cell row.

This achieves the technical advantage that an advantageous assembly sequence can be ensured, in which the heat protection element can be advantageously positioned first, in which the connection element is then connected to the other of the two adjacent battery cells in a non-positive and/or positive manner, and in which the connection element is then connected to one of the two adjacent battery cells in a firmly bonded manner.

In one embodiment, the heat protection element arranged between two battery cells of the respective battery cell row adjacent along the longitudinal direction extends along a transverse direction, which is transverse to the longitudinal direction.

This achieves the technical advantage that a particularly effectively positioned arrangement of the at least one heat protection element within the mounting housing can be ensured.

In one embodiment, the heat protection element has at least one opening, wherein a battery cell, in particular a pole of the battery cell, of the two battery cells of the respective battery cell row arranged adjacent to one another is accommodated at least in sections in the opening, or wherein an electrical connection element of the plurality of electrical connection elements is arranged at least in sections in the opening in order to provide an electrically conductive connection between the two adjacent battery cells of the respective battery cell row.

This achieves the technical advantage that the opening of the at least one heat protection element ensures that there is still an electrically conductive connection between the two adjacent battery cells.

Either a battery cell, in particular a pole of the battery cell, of the two battery cells arranged adjacent to each other can be arranged in the opening or the electrical connection element can be arranged in the opening.

In particular, an opening edge defining the opening may abut the battery cell accommodated at least in sections in the opening in order to ensure that there is no gap between the heat protection element and the battery cell, through which hot gas can penetrate.

In particular, an opening edge defining the opening may abut the electrical connection element arranged at least in sections in the opening in order to ensure that there is no gap between the heat protection element and the electrical connection element, through which hot gas can penetrate.

In one embodiment, the at least one heat protection element comprises a heat protection plate.

This achieves the technical advantage that an effective heat protection barrier can be provided. In particular, the heat protection plate has at least one elevation and/or at least one depression.

In one embodiment, the at least one heat protection element is arranged between two respective battery cells, adjacent along the longitudinal direction, of a plurality of the battery cell rows positioned parallel to one another, wherein the at least one heat protection element is arranged in particular between two respective battery cell rows, adjacent along the longitudinal direction, of all battery cell rows positioned parallel to one another.

This achieves the technical advantage that the at least one heat protection element extends beyond a single battery cell row at a time, and the at least one heat protection element extends into the corresponding battery cell row(s) arranged adjacent to the battery cell row. In particular, the at least one heat protection element extends along a transverse direction extending transversely to the longitudinal direction and/or along a vertical direction extending transversely to the longitudinal direction and transversely to the transverse direction.

Thus, the at least one heat protection element can be arranged between a plurality of battery cells respectively arranged adjacent to each other in the respective battery cell rows along the longitudinal direction, so that an effective heat protection barrier for a plurality of battery cell rows can be enabled by a single heat protection element.

In one embodiment, battery cell rows positioned parallel to each other have the same polarity, and/or two battery cell rows of the battery cell rows positioned parallel to each other have a different polarity.

This achieves the technical advantage of allowing flexible adaptation of the battery mounting system.

If battery cell rows positioned parallel to each other have the same polarity, the poles of the battery cells arranged next to each other in different battery cell rows are the same, i.e. in the corresponding battery cell rows with the same polarity, the arrangement of plus and minus poles is symmetrical.

If, on the other hand, battery cell rows positioned parallel to each other have a different polarity, the poles of the battery cells arranged next to each other in different battery cell rows are different, i.e. in the corresponding battery cell rows with a different polarity, a minus pole is present beside a plus pole of a battery cell in the battery cell arranged next to it in a different battery cell row, and vice versa.

In particular, all battery cell rows positioned parallel to each other have the same polarity.

In particular, two battery cell rows arranged next to each other have a different polarity in all battery cell rows positioned parallel to each other.

In particular, at least some of the battery cell rows positioned parallel to each other have the same polarity and two battery cell rows arranged next to each other in each case have a different polarity in at least some of the battery cell rows positioned parallel to each other.

In one embodiment, two battery cells arranged next to each other in different battery cell rows are arranged without offset to each other, and/or two battery cells arranged next to each other in different battery cell rows are arranged with offset to each other, wherein the offset extends in particular along a longitudinal direction of the battery cell rows.

This achieves the technical advantage that, depending on whether battery cells arranged next to each other in different battery cell rows are arranged with or without an offset to each other, a flexible adaptation of the battery mounting system is made possible, in particular to the contacts of the battery mounting system that are located at the ends of the respective battery cell rows.

In one embodiment, two battery cells arranged next to one another in different battery cell rows are arranged offset from one another, wherein the battery mounting system has at least one first heat protection element and at least one second heat protection element, which are arranged offset from one another, in particular offset by the offset, between in each case two battery cells of the respective battery cell rows that are adjacent along the longitudinal direction.

This achieves the technical advantage that, if the two battery cells arranged next to each other in different battery cell rows are offset from each other, two different heat protection elements are required to ensure that, despite the offset along the longitudinal direction, effective heat protection can be provided between the respective battery cells of the respective battery cell row that are adjacent along the longitudinal direction.

In one embodiment, the first and second heat protection elements each have at least one first opening in which, at least in sections, a pole, in particular a positive pole, of one of the two battery cells of the respective battery cell row that are adjacent along the longitudinal direction is accommodated, and/or wherein the first and second heat protection elements each have at least one second opening in which, at least in sections, one of the two battery cells of the respective battery cell row that are adjacent along the longitudinal direction is accommodated.

This achieves the technical advantage that the two different openings of the first and second heat protection elements are specifically shaped to accommodate the pole of the battery cell, or specifically shaped to accommodate the battery cells, so that despite the offset between two adjacent battery cell rows, an effective heat protection barrier can be ensured between the adjacent battery cells.

In particular, the first opening is designed to accommodate an electrical connection element connected to the pole, especially the positive pole, at least in sections.

In particular, the first opening for accommodating the pole, especially the positive pole, or the electrical connection element, has a smaller diameter than the second opening for accommodating the battery cell.

In one embodiment, each electrical connection element of the plurality of electrical connection elements has a contact region, which is electrically conductively connected to one pole, in particular a positive pole, of one battery cell of the two battery cells adjacent along the longitudinal direction, and which is electrically conductively connected to another pole, in particular a negative pole, of the other battery cell of the two battery cells adjacent along the longitudinal direction.

This achieves the technical advantage that the contact area enables an effective electrically conductive connection between different poles of the two battery cells adjacent along the longitudinal direction.

In one embodiment, the contact area is firmly bonded, in particular welded, soldered and/or glued, to at least one pole, in particular a positive pole, wherein in particular the at least one heat protection element is arranged between the respective electrical connection element of the plurality of electrical connection elements and the pole.

This achieves the technical advantage that a particularly stable attachment of the electrical connection element is made possible via the contact area to at least one pole of at least one of the two battery cells.

In particular, the contact area is firmly bonded to only one pole, in particular the positive pole, of one of the two battery cells adjacent along the longitudinal direction. Alternatively, the contact area is firmly bonded to one pole each, in particular the positive pole and the negative pole, of both battery cells adjacent along the longitudinal direction.

In one embodiment, a plurality of mounting elements, in particular mounting teeth, are arranged on the contact area, which accommodate a cell end of at least one of the two battery cells adjacent along the longitudinal direction.

This achieves the technical advantage that the mounting elements enable effective, in particular non-positive, mounting of the respective cell end, so that the corresponding battery cell simply has to be inserted between the mounting elements to ensure effective fastening.

In one embodiment, the battery mounting system comprises a plurality of heat protection elements arranged spaced apart from each other, in particular spaced apart from each other along a longitudinal direction of the battery cell rows, in the mounting housing, wherein each heat protection element of the plurality of heat protection elements is arranged between two different battery cells of the respective battery cell rows adjacent along the longitudinal direction, respectively, to ensure a heat protection barrier between a plurality of battery cells of the respective battery cell rows adjacent along the longitudinal direction.

This achieves the technical advantage that the plurality of heat protection elements ensures that an effective heat protection barrier is provided for different battery cells of the respective battery cell rows adjacent along the longitudinal direction.

The distance between the correspondingly spaced heat protection elements corresponds in particular to the length of a battery cell.

In one embodiment, the at least one heat protection element is connected to at least one of the two battery cells of the respective battery cell row, which are adjacent along the longitudinal direction, in a firmly bonded, non-positive and/or positive manner.

This achieves the technical advantage of enabling effective attachment of the at least one heat protection element to at least one of the two battery cells, in particular also to both battery cells.

In particular, the at least one heat protection element is connected to at least one electrical connection element of the plurality of electrical connection elements in a firmly bonded, non-positive and/or positive manner.

In one embodiment, the battery cells each have at least one degassing valve, which is designed to discharge gas from the battery cell in the event of excess pressure within the respective battery cell, the at least one degassing valve being arranged in particular in the spatial vicinity of a pole, in particular a plus pole or minus pole, of the respective battery cell.

This achieves the technical advantage that gas can be advantageously released into the environment of the battery cell through the degassing valve in the event of a thermally unstable state of the battery cell in order to prevent the battery cell from bursting.

In particular, the degassing valve is arranged in spatial proximity to a pole, in particular positive pole or negative pole, of the respective battery cell, so that the degassing valve is arranged in spatial proximity to the at least one heat protection element, which is arranged between two battery cells that are adjacent along the longitudinal direction, or between the corresponding poles of the adjacent battery cells, so that gas released through the degassing valve can be effectively dissipated by the at least one heat protection element.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure. An advantageous embodiment of the present invention is set out below with reference to the accompanying figures, wherein:

FIG. 1 depicts a schematic representation of a battery mounting system according to a comparative example;

FIG. 2 depicts a schematic representation of a battery mounting system according to an embodiment example in a horizontal sectional view;

FIG. 3 depicts a schematic representation of a battery mounting system according to the embodiment example in a vertical sectional view;

FIG. 4 depicts a schematic representation of a connection area between two battery cells of a battery mounting system according to the embodiment example;

FIG. 5 depicts a schematic representation of a battery mounting system according to the embodiment example in a perspective view; and

FIG. 6 depicts a schematic representation of a battery mounting system according to the embodiment example in a further perspective view.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

In the following detailed description, reference is made to the accompanying figures, which are a part hereof and which show, by way of illustration, specific embodiments in which the invention may be executed. It is understood that other embodiments may also be used and structural or logical changes may be made without departing from the concept of the present invention. The following detailed description is therefore not to be understood in a limiting sense. It is further understood that the features of the various embodiments described herein may be combined with each other, unless specifically stated otherwise.

The aspect and embodiments of the present invention are described with reference to the figures, wherein the same reference signs generally refer to the same elements. In the following description, numerous specific details are set out for explanatory purposes in order to provide an in-depth understanding of the aspect of the present invention.

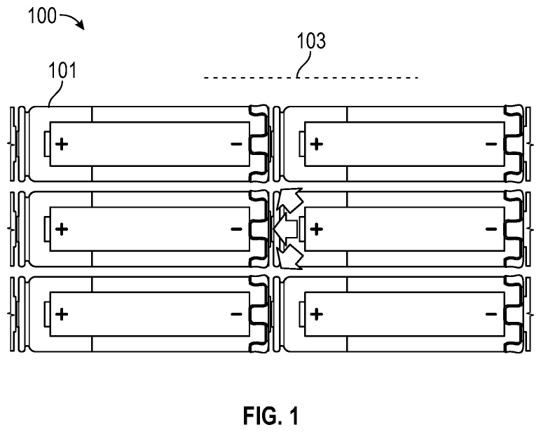

FIG. 1 shows a schematic representation of a battery mounting system according to a comparative example.

The battery mounting system 100 shown only schematically in FIG. 1 enables the mounting of a plurality of battery cells 101 in an electrically drivable vehicle. The battery mounting system 100 has a mounting housing 103, which is only indicated in FIG. 1, for mounting the plurality of battery cells 101.

In a conventional electrically drivable vehicle, a large number of battery cells 101 are required to provide sufficient electrical energy to drive the vehicle. Usually, battery cells 101 based on lithium-ion technology are used for this purpose, which, however, can be converted into a thermally unstable state under certain operating conditions.

For example, if a battery cell 101 is overcharged, if a battery cell 101 overheats and/or if the battery cell 101 is mechanically damaged, a battery cell internal short circuit may occur, which may release a large amount of thermal energy inside the battery cell 101, which in turn may greatly increase the pressure inside the battery cell 101.

In this case, a pressure relief valve, which may be arranged in the battery cell 101, can open and release a significant amount of hot gas into the immediate vicinity of the battery cell 101, as shown schematically by arrow markings in FIG. 1. Due to the often very dense packing of battery cells 101 in a conventionally used mounting housing 103, the correspondingly released hot gas can thermally excite other neighbouring battery cells 101, so that the other neighbouring battery cells 101 can also be brought into a thermally unstable state under certain circumstances.

Under certain circumstances, this can result in a chain reaction, to the extent that a large number of battery cells 101 can be brought into thermally unstable states (“thermal propagation”), as a result of which the entire battery unit of the electrically drivable vehicle can be severely damaged or even destroyed.

For this reason, starting from conventional battery arrangements, the task is to ensure effective heat protection between neighbouring battery cells 101 in order to prevent neighbouring battery cells 101 from also being converted into a thermally unstable state in the event of damage and the resulting release of thermal energy from a single battery cell 101.

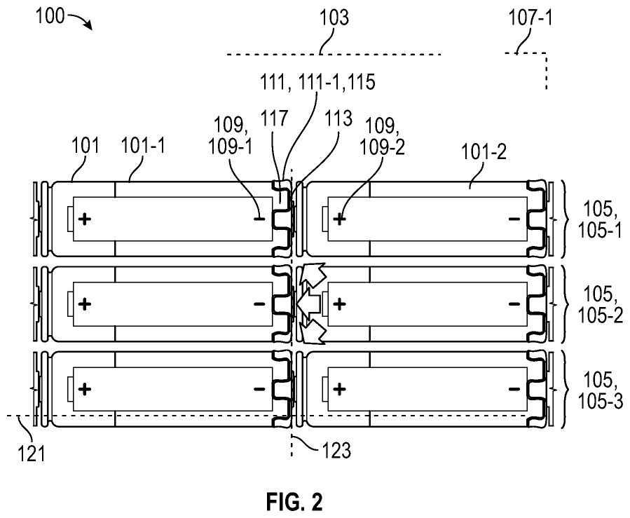

FIG. 2 shows a schematic representation of a battery mounting system according to an embodiment example in a horizontal sectional view.

The battery mounting system 100 has a mounting housing 103, shown only schematically in FIG. 2, for holding a plurality of battery cells 101.

As can be seen from FIG. 2, the battery cells 101 are arranged within the mounting housing 103 in a plurality of battery cell rows 105 positioned parallel to each other. FIG. 2 only shows a section of the mounting housing 103 with a first battery cell row 105-1, a second battery cell row 105-2 positioned parallel to it and a third battery cell row 105-3 positioned parallel to it.

Even though the battery cell rows 105 shown in FIG. 2 are arranged in a single horizontal battery cell plane 107-1, the mounting housing 103 comprises in particular a plurality of horizontal battery cell planes 107-1 arranged one above the other, wherein a plurality of battery cell rows 105 positioned parallel to one another are arranged in each horizontal battery cell plane 107-1 of the plurality of horizontal battery cell planes 107-1 as shown in FIG. 2.

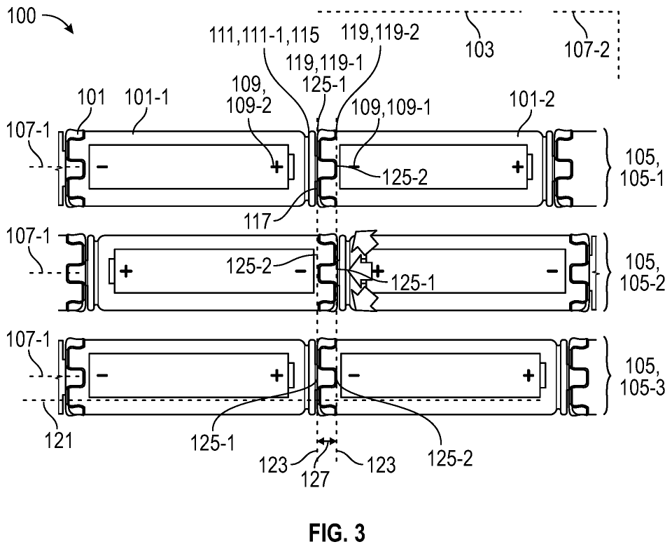

For a vertical sectional view of the corresponding three-dimensional battery mounting system 100, please refer to FIG. 3.

As can be seen from FIG. 2, the battery cells 101 of the respective battery cell row 105, 105-1, 105-2, 105-3 are arranged in an electrical series circuit. This means that two adjacent battery cells 101 of the respective battery cell row 105, 105-1, 105-2, 105-3 are electrically conductively connected to each other along the longitudinal direction 121.

In FIG. 2, a first battery cell 101-1 and a second battery cell 101-2 adjacent to the first battery cell 101-1 in the respective battery cell row 105-1 along the longitudinal direction 121 are shown as examples.

For example, an electrical pole 109, in particular minus pole 109-1, of the first battery cell 101-1 is electrically conductively connected to an opposite electrical pole 109, in particular plus pole 109-2, of the second battery cell 101-2.

Although this is not shown in FIG. 2, an electrical pole 109, in particular plus pole 109-2, of the first battery cell 101-1 may alternatively be electrically conductively connected to an opposite electrical pole 109, in particular minus pole 109-1, of the second battery cell 101-2.

In order to enable an effective electrically conductive connection between two adjacent battery cells 101, 101-1, 101-2 of the respective battery cell row 105, 105-1, 105-2, 105-3, the battery mounting system 100 comprises a plurality of electrical connection elements 111. In each case, one electrical connection element 111 of the plurality of electrical connection elements 111 electrically conductively connects two adjacent battery cells 101, 101-1, 101-2 of the respective battery cell row 105, 105-1, 105-2, 105-3 along the longitudinal direction 121.

In FIG. 2, a first electrical connection element 111 is highlighted which electrically conductively connects the first battery cell 101-1 to the second battery cell 101-2 arranged adjacent to it in the first battery cell row 105-1 along the longitudinal direction 121.

Even though this is only shown schematically in FIG. 2, the electrical connection elements 111 each have a contact area 113, which is electrically conductively connected to a pole 109, in particular plus pole 109-2, of one battery cell 101, 101-1, 101-2 of the two adjacent battery cells 101, 101-1, 101-2, and which is electrically connected to an opposite pole 109, in particular minus pole 109-1, of the other battery cell 101, 101-1, 101-2 of the two adjacent battery cells 101, 101-1, 101-2.

In the illustration chosen in FIG. 2, the contact area 113 of the first electrical connection element 111, which is electrically conductively connected to the minus pole 109-1 of the first battery cell 101-1 and to the plus pole 109-2 of the second battery cell 101-2, is shown only schematically.

In FIG. 2, mounting elements 115, in particular mounting teeth, arranged at the contact area 113 are shown, which enclose a cell end 117 of at least one of the two battery cells 101, 101-1, 101-2 in order to receive the at least one battery cell 101, 101-1, 101-2.

In the representation chosen in FIG. 2, the mounting elements 115 enclose a cell end 117 of the first battery cell 101-1 in order to ensure effective mounting of the first battery cell 101-1. Even though this is not shown in FIG. 2, the contact area 113 of the electrical connection element 111 is firmly bonded, in particular welded, to a pole 109, in particular plus pole 109-2, of the second battery cell 101-2.

Thus, the electrical connection elements 111, 111-1 arranged in each case between two battery cells 101, 101-1, 101-2, adjacent along the longitudinal direction 121, of the respective battery cell rows 105, 105-1, 105-2, 105-3 ensure an effective electrically conductive connection between all adjacent battery cells 101, 101-1, 101-2 in the respective battery cell row 105, 105-1, 105-2, 105-3.

It can be seen from FIG. 2 that the battery cell rows 105, 105-1, 105-2, 105-3 positioned parallel to one another in particular all battery cell rows 105, 105-1, 105-2, 105-3 positioned parallel to one another have the same polarity, so that the poles 109, 109-1, 109-2, 105-3 in the battery cell rows 105 positioned parallel to one another are arranged in the same direction. In particular, two battery cells 101 arranged next to each other in different battery cell rows 105 do not have any offset to each other along the longitudinal direction 121.

As further shown in FIG. 2, the battery mounting system 100 comprises at least one heat protection element 119, in particular a heat protection plate, which is arranged between two battery cells 101, 101-1, 101-2 of the respective battery cell rows 105, 105-1, 105-2 adjacent along the longitudinal direction 121 and is configured to provide a heat protection barrier between the two adjacent battery cells 101, 101-1, 101-2 of the respective battery cell rows 105, 105-1, 105-2, 105-3.

As shown only schematically in FIG. 2, the heat protection element 119 ensures a physical separation between the two battery cells 101, 101-1, 101-2 of the respective battery cell rows 105, 105-1, 105-2, 105-3 adjacent along the longitudinal direction 121, so that in the event of a thermal overload, hot gas escaping from one battery cell 101, 101-1, 101-2 can be retained by the heat protection element 119 from the other battery cells 101, 101-1, 101-2. This can effectively prevent neighbouring battery cells 101, 101-1, 101-2 from also being converted into a thermally unstable state.

In this case, the heat protection element 119 is in particular made of a material with a high temperature and pressure resistance in order to be able to withstand the escaping hot gas and comprises in particular steel, iron and/or aluminium.

As shown in FIG. 2, the battery cells 101, 101-1, 101-2 of the respective battery cell row 105, 105-1, 105-2, 105-3 extend along a longitudinal direction 121 and the heat protection element 119 extends along a transverse direction 123 transverse to the longitudinal direction 121.

Thus, the heat protection element 119 is not only arranged, in each case, between two battery cells 101, 101-1, 101-2 of a single battery cell row 105, 105-1, 105-2, 105-3 adjacent along the longitudinal direction 121, but the heat protection element 119 is in particular arranged, in each case, between two battery cells 101, 101-1, 101-2 of a plurality of the battery cell rows 105, 105-1, 105-2, 105-3 positioned parallel to each other adjacent along the longitudinal direction 121.

Even if only a single horizontal battery cell plane 107-1 is shown in FIG. 2, the heat protection element 119 extends in particular at least in sections, in particular completely, along the transverse direction 123 running transversely to the longitudinal direction 121 in the mounting housing 103 and/or the heat protection element 119 extends in particular at least in sections, in particular completely, along a vertical direction running transversely to the longitudinal direction 121 and transversely to a transverse direction 123 in the mounting housing 103, the vertical direction not being shown in FIG. 2.

Thus, in particular, the heat protection element 119 may be arranged, in each case, between two battery cells 101, 101-1, 101-2 of all battery cell rows 105, 105-1, 105-2, 105-3 positioned parallel to each other adjacent along the longitudinal direction 121.

The heat protection element 119 shown in FIG. 2 may provide a heat protection barrier between two battery cells 101, 101-1, 101-2 of the respective battery cell rows 105, 105-1, 105-2, 105-3 adjacent along the longitudinal direction 121.

Although not shown in FIG. 2, the battery cell rows 105, 105-1, 105-2, 105-3 comprise a plurality of battery cells 101, 101-1, 101-2 arranged along the longitudinal direction 121, so that the battery mounting system 100 may in particular comprise a plurality of further heat protection elements 119, which are not shown in FIG. 2, and which are arranged spaced apart from each other, in particular spaced apart from each other along the longitudinal direction 121, in the mounting housing 103.

Each of the further heat protection elements 119 is here arranged between two different battery cells 101, 101-1, 101-2 of the respective battery cell rows 105, 105-1, 105-2, 105-3 adjacent along the longitudinal direction 121, so that in particular a plurality, in particular all, of the battery cells 101, 101-1, 101-2 adjacent along the longitudinal direction 121 can be effectively thermally decoupled from one another by a heat protection barrier.

Since the at least one heat protection element 119 is arranged between two battery cells 101, 101-1, 101-2 of the respective battery cell rows 105, 105-1, 105-2, 105-3 which are adjacent along the longitudinal direction 121, the at least one heat protection element 119 has, in each case, at least one opening 125, in particular a plurality of openings 125, which is not shown in FIG. 2.

A battery cell 101, 101-1, 101-2 of the two battery cells 101, 101-1, 101-2 of the respective battery cell rows 105, 105-1, 105-2, 105-3 arranged adjacent to each other along the longitudinal direction 121 may be accommodated at least in sections through the opening 125 of the respective heat protection element 119 in order to enable an electrically conductive connection between the two battery cells 101, 101-1, 101-2 arranged adjacent to each other through the heat protection element 119.

An electrical connection element 111 of the plurality of electrical connection elements 111 may be arranged in the opening 125 of the respective heat protection element 119, at least in sections, in order to enable an electrically conductive connection between the two battery cells 101, 101-1, 101-2 arranged adjacent to each other along the longitudinal direction 121 through the heat protection element 119.

Thus, the at least one heat protection element 119 can ensure an effective heat protection barrier between adjacently arranged battery cells 101 of the respective battery cell rows 105.

For further details, please refer to the explanations below.

FIG. 3 shows a schematic representation of a battery mounting system according to the embodiment example in a vertical sectional view.

The battery mounting system 100 shown in FIG. 3 corresponds to the battery mounting system 100 shown in FIG. 2, whereby a vertical sectional view is shown in FIG. 3.

Accordingly, the drawing plane shown in FIG. 3 corresponds to a vertical battery cell plane 107-2 which intersects a plurality of horizontal battery cell planes 107-1 shown only schematically in FIG. 3.

FIG. 3 shows that, in each case, two adjacently arranged battery cell rows 105, 105-1, 105-2, 105-3 of the battery cell rows 105, 105-1, 105-2, 105-3 positioned parallel to each other have a different polarity, and that, in each case, two battery cells 101, 101-1, 101-2 arranged next to each other in different battery cell rows 105, 105-1, 105-2 are in particular arranged with an offset 127 to each other. The offset 127 extends along the longitudinal direction 121 of the battery cell rows 105, 105-1, 105-2, 105-3.

It can be seen from FIG. 3 that the first battery cell row 105, 105-1 and the third battery cell row 105, 105-3 have the same polarity and are arranged without offset 127 to each other, and that the second battery cell row 105, 105-2 has a different polarity to the adjacent first battery cell row 105, 105-1 and to the adjacent third battery cell row 105, 105-3.

The second battery cell row 105, 105-2 is arranged, opposite to the first and third battery cell rows 105, 105-1, 105-3, with an offset 127 along the longitudinal direction 121 of the battery cell rows 105, 105-1, 105-2.

In order to effectively cover all poles 109 of the battery cells 101 in the arrangement shown in FIG. 3, in particular a first heat protection element 119-1 and a second heat protection element 119-2 are necessary, which are arranged offset to each other, in particular offset by the offset 127 to each other, between in each case two battery cells 101 of the respective battery cell rows 105 which are adjacent along the longitudinal direction 121.

It can be seen from FIG. 3 that the diameters of the respective openings 125 of the respective first, or second heat protection element 119-1, 119-2 are differently shaped to accommodate either the battery cells 101 or the electrical connection element 111, respectively the poles 109.

In particular, the cell ends 117 of the battery cells 101, which comprise the plus pole 109-2, are accommodated in first openings 125-1 of the first or second heat protection element 119-1, 119-2. In particular, the battery cells 101 themselves are accommodated in second openings 125-2 of the first and second heat protection elements 119-1, 119-2, the second openings 125-2 in particular having a larger diameter than the first openings 125-1.

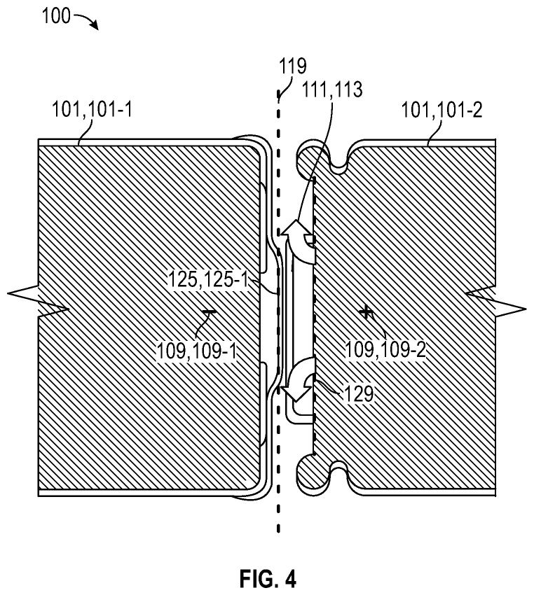

FIG. 4 shows a schematic representation of a connection area between two battery cells of a battery mounting system according to the embodiment example.

In the illustration shown in FIG. 4, the electrical connection area between two battery cells 101 adjacent along the longitudinal direction 121 in a single battery cell row 105 is shown during a thermally unstable state of one of the two battery cells 101.

The first battery cell 101-1 is electrically conductively connected to the second battery cell 101-2 by an electrical connection element 111. A contact area 113 of the electrical connection element 111 establishes contact between a pole 109, in particular minus pole 109-1, of the first battery cell 101-1 and a pole 109, in particular plus pole 109-2, of the second battery cell 101-2.

FIG. 4 also shows the heat protection element 119, which is arranged between the first and second battery cells 101-1, 101-2, wherein a pole 109, in particular the plus pole 109-2, or the electrical connection element 111, is accommodated at least in sections in an opening 125, in particular a first opening 125-1, of the heat protection element 119.

A degassing valve 129 of the second battery cell 101-2, shown only schematically in FIG. 4, opens due to a thermally unstable stat of the second battery cell 101-2, allowing hot gas to escape from the interior of the second battery cell 101-2, and to be effectively discharged through the heat protection element 119 so that degradation of the thermal stability of the first battery cell 101-1 can be prevented.

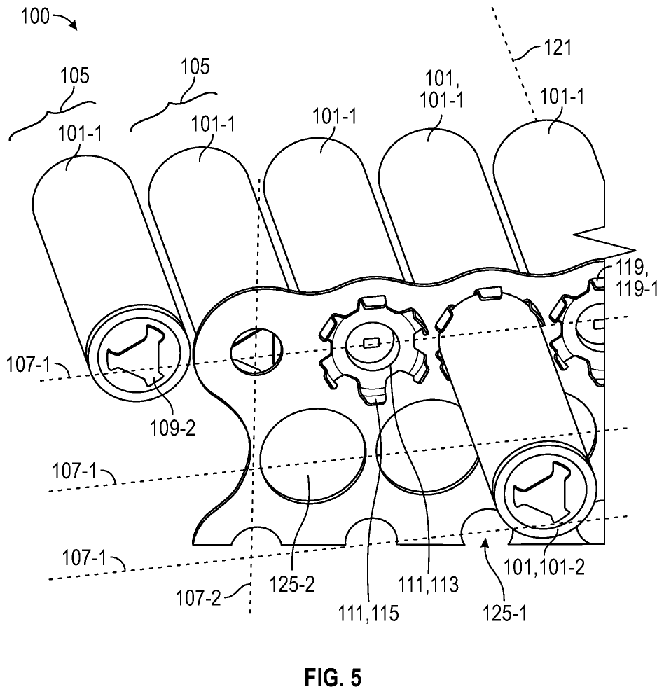

FIG. 5 shows a schematic representation of a battery mounting system according to the embodiment example in a perspective view.

FIG. 5 shows a perspective view of a battery mounting system 100, in particular showing a height and width extension of a heat protection element 119. The horizontal battery cell plane 107-1 shown in FIG. 2 and the vertical battery cell plane 107-2 shown in FIG. 3 are shown schematically in FIG. 5.

FIG. 5 shows the first heat protection element 119-1 shown in FIG. 3.

The heat protection element 119, 119-1 is arranged between two battery cells 101 of the respective battery cell rows 105 that are adjacent along the longitudinal direction 121, and has openings 125 through which the adjacent battery cells 101 are electrically connected.

Due to the offset 127 shown in FIG. 3, the first heat protection element 119-1 shown in FIG. 5 has first openings 125-1 with a smaller diameter, in which a pole 109, in particular plus pole 109-2, or an electrical connection element 111 connected to the pole 109, in particular plus pole 109-2, is accommodated at least in sections. The electrical connection element 111 has a contact area 113 and mounting elements 115 arranged on the contact area 113, which accommodate a cell end 117 of the second battery cell 101-2.

Due to the offset 127 shown in FIG. 3, the first heat protection element 119-1 shown in FIG. 5 has second openings 125-2 with a larger diameter, in each of which, at least in sections, one of the two battery cells 101 of the respective battery cell rows 105 adjacent along the longitudinal direction 121 is accommodated.

In FIG. 5, only the arrangement of the first heat protection element 119-1 between a first battery cell 101-1 and a second battery cell 101-2 is shown, whereby the further second battery cells 101-2 are not shown in the representation selected in FIG. 5. In particular, the heat protection element 119 is connected in a non-positive, positive and/or firmly bonded manner to the adjacent battery cells 101 of the respective battery cell rows 105 arranged adjacent to one another, in particular by laser welding.

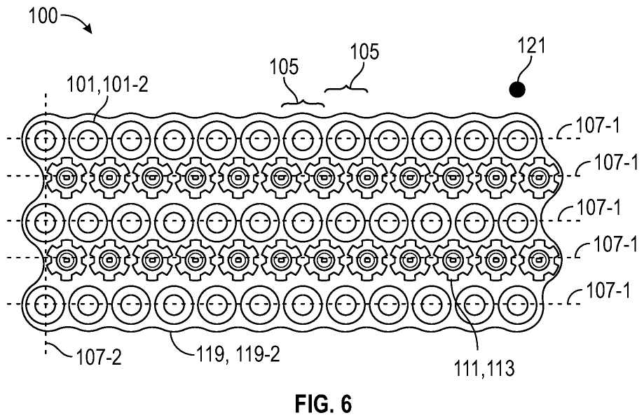

FIG. 6 shows a schematic representation of a battery mounting system according to the embodiment example in a further perspective view.

FIG. 6 shows a perspective view of a battery mounting system 100, in particular showing a height and width extension of a heat protection element 119. The horizontal battery cell plane 107-1 shown in FIG. 2 and the vertical battery cell plane 107-2 shown in FIG. 3 are shown schematically in FIG. 6.

FIG. 6 shows the second heat protection element 119-2 shown in FIG. 3.

The heat protection element 119, 119-2 is arranged between two battery cells 101 of the respective battery cell rows 105, which are adjacent along the longitudinal direction 121, and has openings 125, not shown in FIG. 6, through which the adjacent battery cells 101 are electrically connected.

For technical reasons, only the battery cells 101, in particular second battery cells 101-2, of each second horizontal battery cell level 107-1 are shown in FIG. 6, whereby only the electrical connection elements 111, in particular contact areas 113, are shown in the horizontal battery cell levels 107-1 arranged in between, without the second battery cells 101-2.

The second heat protection element 119-2 shown in FIG. 6 is arranged, in each case, between two battery cells 101 of a plurality of the battery cell rows 105 positioned parallel to each other and spaced along the longitudinal direction 121.

Thus, the heat protection element 119 shown in the embodiment example, in particular first and/or second heat protection element 119-1, 119-2, can ensure an effective thermal boundary between battery cells 101 adjacent along the longitudinal direction 121.

Since the devices and methods described in detail above are examples of embodiments, they can be modified to a wide extent by the skilled person in the usual manner without leaving the scope of the invention. In particular, the mechanical arrangements and the proportions of the individual elements with respect to each other are merely exemplary. Some preferred embodiments of apparatus according to the invention have been disclosed above. The invention is not limited to the solutions explained above, but the innovative solutions can be applied in different ways within the limits set by the claims.

1. A battery mounting system for mounting a plurality of battery cells in an electrically drivable vehicle, the battery mounting system comprising:
a mounting housing configured to accommodate a plurality of battery cells,
the plurality of battery cells accommodated in the mounting housing wherein the battery cells are arranged in a plurality of battery cell rows positioned parallel to each other, wherein the battery cells of the battery cell rows extend along a longitudinal direction,
a plurality of electrical connection elements each electrically conductively connecting two battery cells of the respective battery cell row adjacent to each other along the longitudinal direction so as to provide an electrical series connection of the respective battery cell rows, and
wherein at least one heat protection element is arranged between two battery cells of the respective battery cell row which are adjacent along the longitudinal direction and is formed to provide a heat protection barrier between the two adjacent battery cells of the respective battery cell row.

2. The battery mounting system according to claim 1, wherein the at least one heat protection element is arranged between the respective electrical connection element of the plurality of electrical connection elements and one of the two adjacent battery cells of the respective battery cell row.

3. The battery mounting system according to claim 1, wherein the heat protection element arranged between two battery cells of the respective battery cell adjacent along the longitudinal direction extends along a transverse direction which is transverse to the longitudinal direction.

4. The battery mounting system according to claim 1, wherein:
the heat protection element comprises at least one opening,
one battery cell of the two adjacently arranged battery cells of the respective battery cell row is accommodated in the opening at least in sections, or
wherein an electrical connection element of the plurality of electrical connection elements is arranged in the opening at least in sections in order to provide an electrically conductive connection between the two adjacent battery cells of the respective battery cell row.

5. The battery mounting system according to claim 1, wherein the at least one heat protection element comprises a heat protection plate.

6. The battery mounting system according to claim 1, wherein the at least one heat protection element is arranged between two battery cells which are adjacent along the longitudinal direction, of a plurality of the battery cell rows positioned parallel to one another, the at least one heat protection element being arranged, in each case, in particular between two battery cells adjacent along the longitudinal direction, of all the battery cell rows positioned parallel to one another.

7. The battery mounting system according to claim 1, wherein battery cell rows positioned parallel to one another have the same polarity, and/or wherein, in each case, two adjacently arranged battery cell rows of the battery cell rows positioned parallel to one another have a different polarity.

8. The battery mounting system according to claim 1, wherein, in each case, two battery cells arranged next to one another in different battery cell rows are arranged without offset to one another, and/or wherein two battery cells arranged next to one another in different battery cell rows are arranged with an offset with one another, wherein the offset extends in particular along a longitudinal direction of the battery cell rows.

9. The battery mounting system according to claim 8, wherein:
two battery cells arranged next to one another in different battery cell rows are arranged with an offset with one another,
the battery mounting system comprises at least one first heat protection element and at least one second heat protection element which are arranged offset with one another between two battery cells of the respective battery cell rows which are adjacent along the longitudinal direction.

10. The battery mounting system according to claim 9, wherein the first and second heat protection element each have at least one first opening in which, at least in sections, a pole or a plus pole of one of the two battery cells of the respective battery cell row which are adjacent along the longitudinal direction is accommodated, and/or the first and second heat protection element each have at least one second opening in which, at least in sections, in each case one of the two battery cells of the respective battery cell row which are adjacent along the longitudinal direction is accommodated.

11. The battery mounting system according to claim 1, wherein an electrical connection element of the plurality of electrical connection elements comprises a contact area which is electrically conductively connected to a pole or a plus pole of a battery cell of the two battery cells adjacent along the longitudinal direction, and which is electrically conductively connected to another pole or a minus pole of the other battery cell of the two battery cells adjacent along the longitudinal direction.

12. The battery mounting system according to claim 11, wherein:
the contact area is firmly bonded, welded, soldered and/or glued to at least one pole or plus pole (109-2), and
the at least one heat protection element is arranged between the respective electrical connection element of the plurality of electrical connection elements and the pole.

13. The battery mounting system according to claim 1, wherein:
the battery mounting system comprises a plurality of heat protection elements arranged spaced apart from one another or spaced apart from one another along a longitudinal direction of the battery cell rows in the mounting housing,
each heat protection element of the plurality of heat protection elements is respectively arranged between two different battery cells of the respective battery cell rows adjacent along the longitudinal direction so as to ensure a heat protection barrier between a plurality of battery cells of the respective battery cell rows adjacent along the longitudinal direction.

14. The battery mounting system according to claim 1, wherein the at least one heat protection element is connected to at least one of the two battery cells of the respective battery cell row which are adjacent along the longitudinal direction in a firmly bonded, non-positive and/or positive manner.

15. The battery mounting system according to claim 1, wherein the battery cells comprise at least one degassing valve configured to discharge gas from the battery cell in the event of excess pressure within the respective battery cell, the at least one degassing valve being arranged in spatial vicinity of a pole, plus pole or minus pole of the respective battery cell.
